(19) United States
(12) Patent Application Publication
(10) Pub. No.: US 2025/0224116 A1
(43) Pub. Date: Jul. 10, 2025

(54) PLASMA-ASSISTED MICRO-INJECTOR

(71) Applicant: Southwest Research Institute, San Antonio, TX (US)

(72) Inventors: Francesco DI SABATINO, San Antonio, TX (US); Brian J. CONNOLLY, Englewood, CO (US); Griffin C. BECK, Rio Medina, TX (US)

(21) Appl. No.: 19/009,102

(22) Filed: Jan. 3, 2025

Related U.S. Application Data
(60) Provisional application No. 63/617,742, filed on Jan. 4, 2024.

(51) Int. Cl. F23R 3/36; F23Q 13/00; F23R 3/28; H05H 1/24

(52) U.S. Cl. CPC F23R 3/36; F23Q 13/00; F23R 3/286; F23R 2900/00008; H05H 1/2406; H05H 2245/80

(57) ABSTRACT

A method and apparatus directed at a plasma-assisted micro-injector suitable for turbine engines that allows for the use of different fuels and different fuel mixtures. The plasma-assisted micro-injector generates a non-equilibrium type plasma across the fuel or fuel mixture that improves combustion performance.

### FIELD

The present invention stands directed to a plasma-assisted micro-injector suitable for turbine engines that allows for the use of different fuels and different fuel mixtures. The plasma-assisted micro-injector generates a non-equilibrium type plasma across the fuel or fuel mixture that improves combustion performance.

### BACKGROUND

The need for fuel-flexible combustion technologies for use in turbine engines has become a critical consideration, especially with the goal of reducing implementation costs for relatively low carbon or carbon-free fuels such as ammonia, hydrogen and sustainable aviation fuels (SAFs). While SAFs are designed to be drop-in fuels, incorporating ammonia and hydrogen is likely to require substantial system modifications to ensure relatively efficient and safe combustion with relatively low emissions.

The present invention is contemplated to provide a plasma-assisted micro-injector suitable for turbine engines that would provide a combustion system that is fuel-flexible, meaning that it would be suitable for application to a diverse variety of fuels or fuel mixtures with relatively lower implementation costs and reduced pollution output.

### SUMMARY

A method for combustion of a selected combustible fuel and/or combustible fuel mixture comprising supplying a plasma-assisted micro-injector comprising a high voltage electrode providing a voltage of less than 10 kV, a ground electrode within the high voltage electrode, wherein the plasma-assisted microinjector has a discharge gap of less than 1.0 mm. One then provides a selected combustible fuel or combustible fuel mixture including an oxidizer to the plasma-assisted micro-injector and forms a non-equilibrium plasma across the selected combustible fuel or combustible fuel mixture and combusts the combustible fuel or combustible fuel mixture.

A method for combustion of a selected sustainable aviation fuel comprising supplying a plasma-assisted micro-injector comprising a high voltage electrode providing a voltage of less than 10 kV, a ground electrode within said high voltage electrode, wherein the plasma-assisted microinjector has a discharge gap of less than 1.0 mm with a distance between the ground electrode and the high voltage electrode of less than or equal to 0.5 mm. One then provides a sustainable aviation fuel made from non-petroleum based sources including an oxidizer to the plasma-assisted micro-injector and forms a non-equilibrium plasma across the selected sustainable aviation fuel and combusts the sustainable aviation fuel.

A plasma-assisted microinjector comprising a high voltage electrode providing a voltage of less than 10 kV, a ground electrode within the high voltage electrode providing a space for a selected combustible fuel or combustible fuel mixture, the plasma-assisted microinjector having a discharge gap of less than 1.0 mm. The plasma-assisted micro injector is configured to provide a non-equilibrium plasma to the selected combustible fuel or combustible fuel mixture along with combustion.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 depicts in cross-section a preferred plasma-assisted micro-injector.

FIG. 2 depicts a plurality of preferred plasma-assisted micro-injectors.

### DETAILED DESCRIPTION

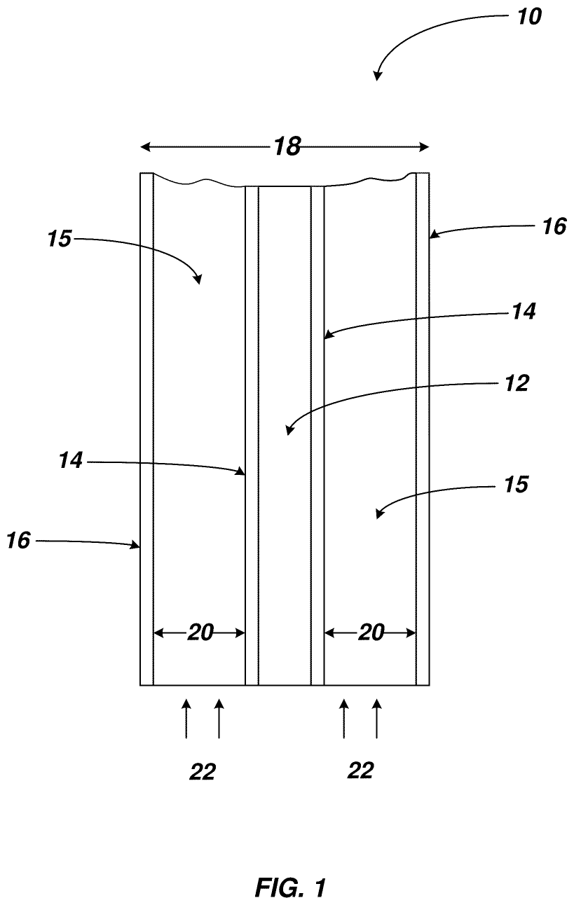

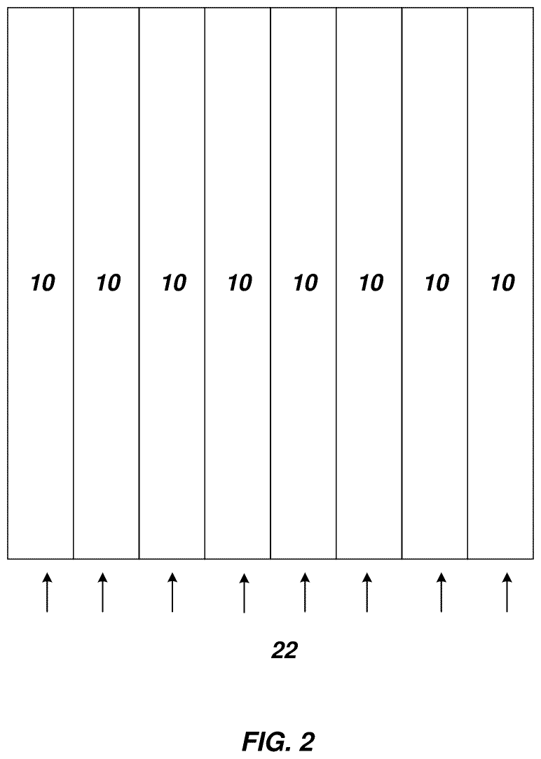

A contemplated plasma-assisted micro-injector 10 suitable for turbine engines is illustrated in FIG. 1. The plasma-assisted micro-injector 10 preferably has a tubular shape, but other shapes are contemplated. The plasma-assisted micro-injector 10 preferably includes an inner ground electrode 12, dielectric material 14 and an outer high voltage electrode 16. As illustrated, the inner ground electrode 12 is preferably positioned within and is surrounded by the outer high voltage electrode 16. As next shown in FIG. 2, one can assemble a plurality of plasma-assisted micro-injectors 10 having the features described herein that is suitable for a given turbine engine requirement.

The high voltage electrode 16 is preferably provided with a voltage of less than 10 kV, and more preferably in the range of 5 kV to less than 10 kV, including all values and increments therein. Accordingly, the high voltage electrode 16 may have a voltage of 5 kV, 6 kV, 7 kV, 8 kV, 9 kV to less than 10 kV. The diameter or discharge gap 18 of the plasma-assisted micro-injector 10 is preferably less than 1.0 mm, more preferably in the range of 0.2 mm to 0.9 mm, or 0.3 mm to 0.5 mm, including all values and increments therein. The space or distance between the ground electrode 12 and high voltage electrode 16, shown at 20, is preferably less than or equal to 0.5 mm, or in the range of 0.1 mm to 0.5 mm.

The plasma-assisted micro-injector 10 accepts a diverse range of selected combustible fuels or combustible fuel mixtures 22, along with an oxidizer, as more fully discussed herein, and is contemplated to then provide a non-equilibrium plasma 15 across the selected combustible fuel or combustible fuel mixtures introduced therein. As can therefore be seen in FIG. 1, the selected combustible fuel or combustible fuel mixture is introduced into space 20 between the ground electrode 12 and high voltage electrode 16 where the non-equilibrium plasma is formed. A non-equilibrium plasma 15 may be understood herein as a plasma which is not in thermodynamic equilibrium, where the electron temperature is hotter than the temperature of the relatively heavy species present (ions and neutrals).

As further illustrated in FIG. 1, it is therefore contemplated that the combustible fuel or combustible fuel mixture is introduced into the plasma micro-injector 10 and then treated by a non-equilibrium plasma. As shown in FIG. 2, one may utilize a plurality of plasma micro-injectors 10 and the combination of non-equilibrium plasma and combustible fuel so formed may be ignited and combusted and the energy produced can be used to therefore power a turbine engine. The turbine engine may be associated with an aircraft or in other applications such as commercial power generation.

As noted above, the plasma micro-injector herein can be utilized with a diverse number of combustible fuels and combustible fuel mixtures along with an appropriate oxidizer (e.g. air or oxygen). It is contemplated that the plasma micro-injector may is particularly suitable for use with one or more of the following fuels: SAFs, hydrogen, ammonia, methane, and kerosene-based jet fuels such as Jet A or Jet A-1. Jet-A has a freeze point of −40° C. or below whereas Jet A-1 has a freeze point of −47° C. or below.

In particular, the plasma micro-injector is contemplated to be suitable for use with diverse combustible fuel mixtures, such as Jet A or Jet A-1, which can be individually combined with SAFs. In such mixtures, the level of Jet-A or Jet A-1 may range from 1.0% to 99.0% by weight and the level of SAFs may range from 99.0%-1.0% by weight. One contemplated preferred mixture would include Jet A or Jet A-1 at 40.0% to 60.0% by weight and SAFs at 60.0% to 40.0% by weight. One particularly preferred mixture would therefore include jet fuel (made from petroleum-based sources), such as Jet A or Jet A-1, at 50.0%±5.0% by weight and SAFs at 50.0%±5.0% by weight.

In the broad context of the present invention, SAFs herein include fuels made from non-petroleum based sources, such as biomass and waste resources that are configured to provide the performance of petroleum-based jet fuel but with a reduced carbon footprint and the ability to reduce the production of greenhouse gas (GHG) during flight. SAFs may therefore include as components alkanes, aromatic hydrocarbons and hydrocarbons of the alkene type.

Current feedstocks to produce SAF include but are not limited to cooking oil and other non-palm waste oils from animals or plants, solid waste from homes and businesses, such as packaging, paper, textile and food scraps that would otherwise go to landfill or incineration. SAFs are also contemplated for production from forestry waste, such as waste wood and energy crops, plants and algae.

Expanding on the above, the plasma micro-injector is contemplated to burn the diverse fuels and combustible mixtures herein while otherwise minimizing changes to the combustion system. The plasma micro-injector is therefore contemplated to allow for use with different fuel combinations while reducing or eliminating the need for geometric or system modifications to the combustion system. As noted above, the preferred diameter or discharge gap of the plasma micro-injector is contemplated to allow for the use of relatively lower breakdown voltage to generate a discharge at relevant operating pressures enabling the above-described fuel-flexibility based on the formation of the non-equilibrium plasma, which in effect is contemplated to make any given fuel mixture chemically more active to downstream combustion.

1. A method for combustion of a selected combustible fuel and/or combustible fuel mixture comprising:
supplying a plasma-assisted micro-injector comprising a high voltage electrode providing a voltage of less than 10 kV, a ground electrode within said high voltage electrode, wherein the plasma-assisted microinjector has a discharge gap of less than 1.0 mm;
providing a selected combustible fuel or combustible fuel mixture including an oxidizer to said plasma-assisted micro-injector;
forming a non-equilibrium plasma across said selected combustible fuel or combustible fuel mixture; and
combusting said combustible fuel or combustible fuel mixture.

2. The method of claim 1 wherein said plasma-assisted microinjector discharge gap is in the range of 0.2 mm to 0.9 mm.

3. The method of claim 1 wherein said plasma-assisted microinjector discharge gap is in the range of 0.3 mm to 0.5 mm.

4. The method of claim 1 comprising providing said high-voltage electrode a voltage in the range of 5 kV to less than 10 kV.

5. The method of claim 1 wherein said plasma-assisted microinjector has a distance between said ground electrode and said high voltage electrode of less than or equal to 0.5 mm.

6. The method of claim 1 wherein said selected combustible fuel comprises sustainable aviation fuel made from non-petroleum based sources.

7. The method of claim 1 wherein said selected combustible fuel mixture comprises sustainable aviation fuel made from non-petroleum based sources and jet fuel made from petroleum based sources.

8. The method of claim 7 wherein said jet fuel made from petroleum based sources is present at 1.0% by weight to 99.0% by weight and said sustainable aviation fuel made from non-petroleum based sources is present at 99.0% by weight to 1.0% by weight.

9. The method of claim 7 wherein said jet fuel made from petroleum based sources is present at 40.0% by weight to 60.0% by weight and said sustainable aviation fuel made from non-petroleum based sources is present at 60.0% by weight to 40.0% by weight.

10. The method of claim 7 wherein said jet fuel made from petroleum based sources is present at 50.0%±5.0% by weight and said sustainable aviation fuel made from non-petroleum based sources is present at 50.0%±5.0% by weight.

11. The method of claim 7 wherein said jet fuel made from petroleum based sources comprises Jet A or Jet A-1.

12. A method for combustion of a selected sustainable aviation fuel comprising:
supplying a plasma-assisted micro-injector comprising a high voltage electrode providing a voltage of less than 10 kV, a ground electrode within said high voltage electrode, wherein the plasma-assisted microinjector has a discharge gap of less than 1.0 mm and a distance between said ground electrode and said high voltage electrode of less than or equal to 0.5 mm;
providing a sustainable aviation fuel made from non-petroleum based sources including an oxidizer to said plasma-assisted micro-injector;
forming a non-equilibrium plasma across said selected sustainable aviation fuel; and
combusting said sustainable aviation fuel.

13. The method of claim 12 wherein said sustainable aviation fuel is present as a mixture with jet fuel made from petroleum based sources.

14. The method of claim 13 wherein said jet fuel made from petroleum based sources is present at 1.0% by weight to 99.0% by weight and said sustainable aviation fuel made from non-petroleum based sources is present at 99.0% by weight to 1.0% by weight.

15. The method of claim 13 wherein the level of said jet fuel made from petroleum based sources is present at 40.0% by weight to 60.0% by weight and said sustainable aviation fuel made from non-petroleum based sources is present at a level of 60.0% by weight to 40.0% by weight.

16. The method of claim 13 wherein said jet fuel made from petroleum based sources is present at 50.0%±5.0% by weight and said sustainable aviation fuel made from non-petroleum based sources is present at 50.0%±5.0% by weight.

17. The method of claim 13 wherein said jet fuel made from petroleum based sources comprises Jet A or Jet A-1.

18. The method of claim 12 wherein said plasma-assisted microinjector discharge gap is in the range of 0.2 mm to 0.9 mm.

19. The method of claim 12 comprising providing said high-voltage electrode a voltage in the range of 5 kV to less than 10 kV.

20. A plasma-assisted microinjector comprising:
a high voltage electrode providing a voltage of less than 10 kV, a ground electrode within said high voltage electrode providing a space for a selected combustible fuel or combustible fuel mixture, the plasma-assisted microinjector having a discharge gap of less than 1.0 mm; and
wherein said plasma-assisted micro injector is configured to provide a non-equilibrium plasma to said selected combustible fuel or combustible fuel mixture along with combustion.
